(19) United States
(12) Patent Application Publication
(10) Pub. No.: US 2017/0109714 A1
(43) Pub. Date: Apr. 20, 2017

(54) METHOD FOR DETECTING AND TRACKING CORRESPONDENT ITEMS FROM U.S. SUBSIDIARIES OF INTERNATIONAL BANKS

(71) Applicant: Early Warning Services, LLC, Scottsdale, AZ (US)

(72) Inventors: Ronald Scott Alcorn, Austin, TX (US); Jie He, Naperville, IL (US); Ravi Loganathan, Charlotte, NC (US)

(73) Assignee: Early Warning Services, LLC, Scottsdale, AZ (US)

(21) Appl. No.: 15/294,205

(22) Filed: Oct. 14, 2016

Related U.S. Application Data
(60) Provisional application No. 62/242,790, filed on Oct. 16, 2015.

(51) Int. Cl. G06Q 20/04; G06Q 20/40

(52) U.S. Cl. CPC G06Q 20/042; G06Q 20/4016

(57) ABSTRACT

Check transaction data is analyzed to identify checks drawn on U.S. subsidiaries of international financial institutions. The accounts into which the identified checks are determined, and the owners of the accounts identified. The number, amounts, and frequency of such deposits may be indicative of certain types of fraud. Deposits of checks drawn on U.S. subsidiaries of international financial institutions may be detected across a plurality of accounts owned by the same owner at different depository institutions.

### CROSS-REFERENCES TO RELATED APPLICATIONS

This Application claims priority to U.S. Provisional Patent Application Number 62/242,790, filed Oct. 16, 2015, entitled “METHOD FOR DETECTING AND TRACKING CORRESPONDENT ITEMS FROM U.S. SUBSIDIARIES OF INTERNATIONAL BANKS,” the entire disclosure of which is hereby incorporated by reference, for all purposes, as if fully set forth herein.

### BACKGROUND OF THE INVENTION

Financial institutions may collect large amounts of information on accounts used for transactions. Such information may be used for various purposes, for example to authenticate persons conducting transactions, and to detect the occurrence of transactions that are suspected of being fraudulent. Information may be collected from many sources and in many different forms, and as such it may be difficult to understand how different pieces of information may relate to a specific person or transaction.

In addition, regulatory authorities in many countries including the United States require banks and other financial institutions to conduct a level of due diligence to verify the identities of their customers, in an effort to detect and prevent various kinds of fraud. This diligence is sometimes called a “Know Your Customer” program.

### BRIEF SUMMARY OF THE INVENTION

According to one aspect, a computerized system comprises a processor and data storage. The data storage holds one or more databases holding records of check-based financial transactions and other information. The system is specially programmed to identify from the one or more computerized databases a number of checks that have been drawn on U.S. subsidiaries of international financial institutions. For each of the identified checks, the owner of the account into which the check was deposited is identified. For each of a number of identified account owners, the number of the identified checks deposited into one or more accounts owned by the respective identified owner is counted. The system produces a report of the respective number of identified checks deposited into one or more accounts owned by the respective identified owners.

According to another aspect, a method comprises maintaining one or more computerized databases holding records of check-based financial transactions and other information and identifying from the one or more computerized databases a number of checks that have been drawn on U.S. subsidiaries of international financial institutions. The method further comprises, for each of the identified checks, identifying the owner of the account into which the check was deposited, and for each of a number of identified account owners, counting the number of the identified checks deposited into one or more accounts owned by the respective identified owner. The method further comprises producing a report of the respective number of identified checks deposited into one or more accounts owned by the respective identified owners.

### BRIEF DESCRIPTION OF THE DRAWINGS

FIG. 1 illustrates a system in accordance with embodiments of the invention.

FIG. 2 illustrates a flow chart of a method in accordance with embodiments of the invention.

FIG. 3 illustrates a block diagram illustrating an exemplary computer system upon which embodiments of the present invention may be implemented.

### DETAILED DESCRIPTION OF THE INVENTION

Embodiments of the invention provide methods and systems for analyzing information about transactions conducted between certain types of financial institutions. Such techniques may be helpful in uncovering fraud such as money laundering, or as part of a Know Your Customer program.

Money laundering is the process of concealing the existence, source, or use of funds, to make the funds appear legitimately obtained or used. While there are many money laundering schemes, some schemes involve the international transfer of money, to conceal the source of funds or to at least make the source more difficult to discern. Given the large number of financial transactions conducted daily, identifying transactions that are suspicious may be a daunting task.

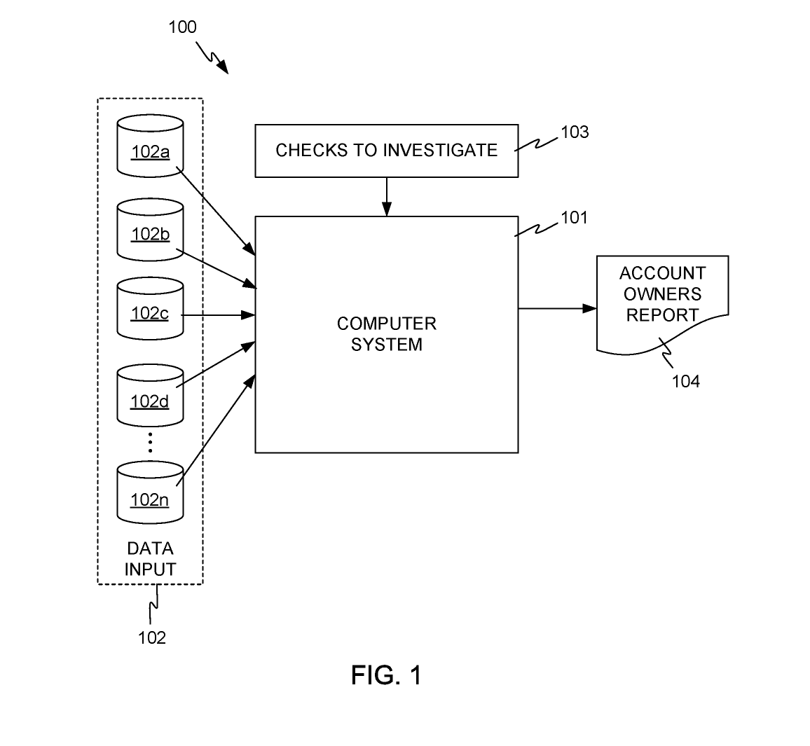

FIG. 1 illustrates a system 100 in accordance with embodiments of the invention. A computer system 101 is coupled to one or more databases 102, holding records of check-based financial transactions and other information. Databases 102 may be organized in any suitable manner. For example, all of the stored information may be considered to be one large database 102, or the information may be considered to be organized into a number of specialized databases. For example, one database 102a may hold a list of check transactions with descriptive data about each check, another database 102b may hold a cross-reference table that correlates bank information numbers (BIN) with the names of their corresponding financial institutions, another database 102c may correlate bank account numbers with the names of the owners of the accounts, and so forth.

Preferably, the information in databases 102 is gathered from a number of financial institutions. That is, databases 102 preferably contain records of check-based financial transactions occurring at and between a number of banks or other institutions, and may contain account ownership records for a number of accounts at a number of banks or other institutions.

Computer 101 is specially programmed to use information from databases 102 to identify checks that have been drawn on U.S. subsidiaries of international financial institutions such as banks, and the owners of accounts into which such checks have been deposited. For example, computer system 101 may be specially programmed to implement the techniques described in more detail below. A check drawn on a U.S. subsidiary of an international financial institution may be termed a “correspondent” item, and in particular an “international correspondent item”. A correspondent bank is one that conducts transactions on behalf of another institution. Correspondent relationships often exist between banks in different countries, but may also exist between institutions within a country. The use of correspondent banks may signal an international transfer, and coupled with other banking patterns may raise a suspicion of money laundering.

Computer system 101 is supplied with an indication 103 of which checks to investigate, for example a list of checks, analyzes the checks in light of information from databases 102, and produces a report 104 of its analysis.

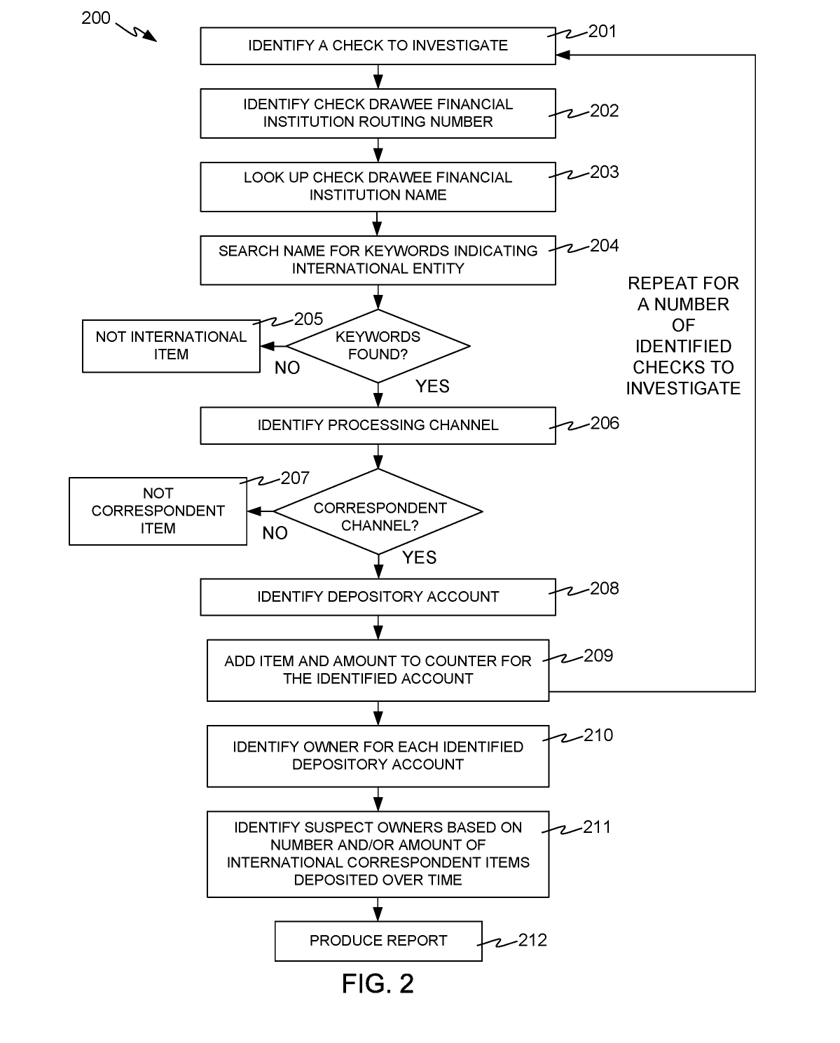

FIG. 2 illustrates a flow chart of a method 200 in accordance with embodiments of the invention, including steps that may be performed by computer system 101. Because no individual item of information in databases 102 may explicitly identify a check as having been drawn on a U.S. subsidiary of an international bank, information from a number of sources may be combined to deduce the status of a particular check.

In step 201, a check of interest is identified for investigation. For example, a particular financial institution may supply a list of checks to be investigated and a particular check to be investigated may be selected from the list, or a check to be investigated may be identified in some other way.

In step 202, the bank identification number (BIN) of the institution on which the check is drawn is identified. For example, this may be accomplished by parsing the transaction information for the check in one of databases 102.

In step 203, the name of the drawee financial institution is determined from the BIN. In some embodiments, the institution name may be determined using a straightforward table lookup in one of databases 102. For example, one of databases 102 may contain the Thomson Bank Directory or a similar listing that correlates BINs with the names of their associated banks.

Once the name of the drawee bank is known, it may be “text mined” to assess whether the name suggests that the drawee financial institution is an international bank, using a keyword search as is shown in step 204 or another method. For example, the bank name may include one or more words like “international” or “global”, or may contain the name of a foreign country, for example “Bank of Canada”. Other keywords or phrases may be used as well. In some embodiments, an institution name containing one or more such words or phrases may be taken to be the name of an international bank. An institution name lacking any such words or phrases may be taken to be the name of a domestic institution.

In step 205, if no suggestion of an international transaction was found in the drawee institution name, it may be presumed that the check being analyzed was not drawn on a U.S. subsidiary of an international bank, at least because the drawee institution does not appear to be international.

When the drawee name indicates an international item, then the check can be further analyzed to ascertain whether it was also drawn on a U.S. subsidiary of an international bank.

Another of databases 102 may contain additional information about each of the check-based financial transactions, for example information indicating how the check was processed or received. One particular code may indicate that a check was processed as a correspondent item.

In step 206, the processing channel code is checked to see if it indicates a correspondent item. If not, it may be presumed in step 207 that the check is not a correspondent item, and therefore also not an international correspondent item. However, when the channel code indicating a correspondent item is found for a particular check that has already been deemed to have been drawn on an international bank, there is a strong presumption that the check was drawn on a U.S. subsidiary of the international bank because the check is both 1) drawn on an international institution and 2) a correspondent item.

Once a check is identified as an international correspondent item, the account to which the check was deposited is identified in step 208. For this purpose, one or more of databases 102 may contain account records from a number of financial institutions. The “depository account” to which the check was deposited is identified in the check transaction information in databases 102.

As multiple checks are processed, a tally is kept in step 209 for each depository account that has received checks drawn on U.S. subsidiaries of international financial institutions (international correspondent items). The tally may include the number of such checks deposited into each respective account, aggregate amounts of such checks, or both. Other information could be tracked as well, for example the sizes of the deposits, the frequency of the deposits, and or other information.

A number of checks may be investigated in this manner, with the account-specific tallies accumulating the numbers and amounts of the identified deposits, and possibly other information.

In step 210, the owner of each of the identified accounts is ascertained. For example, the name of the owner of each depository account may be retrieved from account information supplied by various financial institutions and stored in one of databases 102.

The list of identified owners is further analyzed in step 211 to identify persons owning accounts that collectively receive unusual numbers of deposits by international correspondent items over a period of time, even if the deposits are spread among a number of different depository institutions. For example, the analysis may detect that person A owns an account at financial institution #1 that has received seven international correspondent item deposits totaling $8,000 during the past 14 days, and that person A also owns an account at financial institution #2 that has received nine international correspondent item deposits totaling $14,000 during the past 14 days. This analysis may be referred to as a “cross-bank” or “cross-financial institution” analysis, because it can detect activities by a single person at a number of institutions.

Thus, owners of accounts with unusually high receipts or rates of receipt of international correspondent item deposits may be identified.

In some embodiments, receiving any deposits of international correspondent items in any amount may be considered to be an unusually high receipt or rate of receipt of international correspondent item deposits. In other embodiments, an unusually high receipt or rate of receipt of international correspondent item deposits may be, for example:
receipt of two, three, five, 10, or another number of such deposits within a predetermined time period such as 1, 2, 5, 7, 10, 14, 21, 30 or another number of days;
receipt of deposits of international correspondent items totaling at least $100, $200, $500, $1000, $2000, $5000, $10,000, $20,000, $50,000, $100,000, or another amount within a predetermined time period such as 1, 2, 5, 7, 10, 14, 21, 30 or another number of days; or
receipt of an above average number of international correspondent item deposits as compared with a typical account within a predetermined time period such as 1, 2, 5, 7, 10, 14, 21, 30 or another number of days;
receipt of 2, 3, 5, or 10 times or another multiple of the average number of international correspondent item deposits as compared with a typical account within a predetermined time period such as 1, 2, 5, 7, 10, 14, 21, 30 or another number of days; or
receipt of 2, 3, 5, or 10 times or another multiple of the average dollar amount of international correspondent item deposits as compared with a typical account within a predetermined time period such as 1, 2, 5, 7, 10, 14, 21, 30 or another number of days.
   Other definitions of an unusually high receipt or rate of receipt of international correspondent item deposits may also be used. Owners whose accounts have received international correspondent item deposits in unusually high amounts or at unusually high rates may be flagged, for example for further investigation.

In step 212, a report of the analysis is produced, for example report 104 shown in FIG. 1. The report may include various kinds of information, including any one, any combination, or all of a) the number international correspondent items deposited into a particular account over a period of time, b) the total monetary amount of international correspondent items deposited into a particular account, c) the number of accounts owned by a particular person and having received deposits of international correspondent items, and d) the total monetary amount of deposits of international correspondent items received into a particular account or accounts owned by a particular person individual. Each of these items may be repeated for other accounts and account owners, and any monetary amount may also be indicated as a rate. For example, the total monetary amount of international correspondent items deposited into a particular account may be reported as the total amount deposited over a period of time. Other information may be included as well.

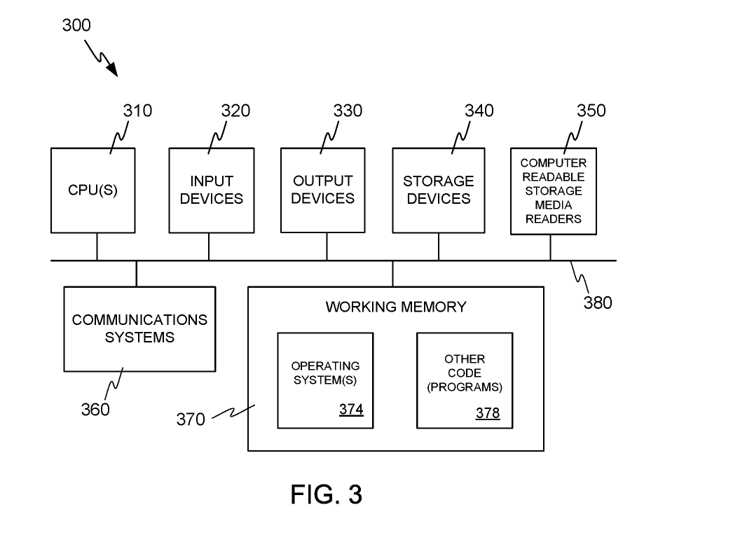

FIG. 3 is a block diagram illustrating an exemplary computer system 300 upon which embodiments of the present invention may be implemented. This example illustrates a computer system 300 such as may be used, in whole, in part, or with various modifications, to provide the functions of the system 100, as well as other components and functions of the invention described herein.

The computer system 300 is shown comprising hardware elements that may be electrically coupled via a bus 380. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage devices 340, representing remote, local, fixed, and/or removable storage devices and storage media for temporarily and/or more permanently containing computer-readable information, and one or more storage media reader(s) 350 for accessing the storage device(s) 340. By way of example, storage device(s) 340 may be disk drives, optical storage devices, solid-state storage device such as a random access memory (“RAM”) and/or a read-only memory (“ROM”), which can be programmable, flash-updateable or the like.

The computer system 300 may additionally include a communications system 360 (e.g., a modem, a network card—reless or wired, an infra-red communication device, a Bluetooth™ device, a near field communications (NFC) device, a cellular communication device, etc.) The communications system 360 may permit data to be exchanged with a network, system, computer, mobile device and/or other component as described earlier. The system 300 also includes working memory 370, which may include RAM and ROM devices as described above.

The computer system 300 may also comprise software elements, shown as being located within a working memory 370, including an operating system 374 and/or other code 378. Software code 378 may be used for implementing functions of various elements of the architecture as described herein. For example, software stored on and/or executed by a computer system, such as system 300, can be used in implementing the processes seen in FIG. 2.

It should be appreciated that alternative embodiments of a computer system 300 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration.

Similarly, while various functionalities are ascribed to certain individual system components, unless the context dictates otherwise, this functionality can be distributed or combined among various other system components in accordance with different embodiments of the invention. As one example, the system 100 system may be implemented by a single system having one or more storage device and processing elements.

Moreover, while the various flows and processes described herein (e.g., those illustrated in FIG. 2) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes;

likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computerized system, comprising:
a processor; and
data storage, the data storage holding one or more databases holding records of check-based financial transactions and other information;
wherein the system is specially programmed to:
identify from the one or more computerized databases a number of checks that have been drawn on U.S. subsidiaries of international financial institutions;
for each of the identified checks, identify the owner of the account into which the check was deposited;
for each of a number of identified account owners, count the number of the identified checks deposited into one or more accounts owned by the respective identified owner; and
produce a report of the respective number of identified checks deposited into one or more accounts owned by the respective identified owners.

2. A method, comprising:
maintaining one or more computerized databases holding records of check-based financial transactions and other information;
identifying from the one or more computerized databases a number of checks that have been drawn on U.S. subsidiaries of international financial institutions;
for each of the identified checks, identifying the owner of the account into which the check was deposited;
for each of a number of identified account owners, counting the number of the identified checks deposited into one or more accounts owned by the respective identified owner; and
producing a report of the respective number of identified checks deposited into one or more accounts owned by the respective identified owners.

3. The method of claim 2, wherein identifying a number of checks that have been drawn on U.S. subsidiaries of international financial institutions further comprises, for each of a number of checks being investigated:
identifying the check drawee financial institution from a routing number of a respective check;
looking up the name of the drawee financial institution in the one or more computerized databases;
searching the name of the drawee financial institution for text indicating that the drawee financial institution is an international financial institution; and
identifying the respective check as having been drawn on a U.S. subsidiary of an international financial institution based in part on the results of the keyword search.

4. The method of claim 2, wherein identifying a number of checks that have been drawn on U.S. subsidiaries of international financial institutions further comprises, for each of the number of checks being investigated:
identifying a deposit channel of the respective check from data in the one or more computerized databases; and
identifying the respective check as having been drawn on a U.S. subsidiary of an international financial institution based in part on the deposit channel identification.

5. The method of claim 2, wherein identifying a number of checks that have been drawn on U.S. subsidiaries of international financial institutions further comprises, for each of a number of checks being investigated:
identifying the check drawee financial institution from a routing number of a respective check;
looking up the name of the drawee financial institution in the one or more computerized databases;
searching the name of the drawee financial institution for text indicating that the drawee financial institution is an international financial institution;
identifying a deposit channel of the respective check from data in the one or more computerized databases; and
identifying the respective check as having been drawn on a U.S. subsidiary of an international financial institution based in part on the results of the keyword search and based in part on the deposit channel identification.

6. The method of claim 5, wherein a particular check is identified as having been drawn on a U.S. subsidiary of an international financial institution when:
a) the name of the drawee financial institution of the check contains one or more key words indicating that the drawee financial institution is an international financial institution; and
b) the deposit channel of the check is identified as a correspondent channel.

7. The method of claim 2, further comprising, for each of the number of identified account owners, counting the dollar amount of the identified checks deposited into one or more accounts owned by the respective identified owner.

8. The method of claim 7, further comprising identifying in the report one or more account owners whose accounts have received an unusually high dollar amount of international correspondent item deposits within a predetermined time period.

9. The method of claim 2, further comprising, for each of the number of identified account owners, computing a rate of receipt of funds from the identified checks by the respective identified owner.

10. The method of claim 9, further comprising identifying in the report one or more account owners whose accounts have an unusually high rate of receipt of funds from international correspondent item deposits within a predetermined time period.

11. The method of claim 2, wherein:
the one or more computerized databases hold records of check-based financial transactions conducted at a number of different financial institutions; and
counting the number of the identified checks deposited into one or more accounts owned by the respective identified owner comprises counting the number of the identified checks deposited into accounts at different financial institutions.
